(19) United States
(12) Patent Application Publication
(10) Pub. No.: US 2006/0267841 A1
(43) Pub. Date: Nov. 30, 2006

(54) Position determination with peer-to-peer communication

(76) Inventors: Chong U. Lee, San Diego, CA (US); Jeremy M. Stein, Haifa (IL); Leonid Sheynblat, Hillsborough, CA (US)

Correspondence Address: QUALCOMM INCORPORATED, 5775 MOREHOUSE DR., SAN DIEGO, CA, 92121, US

(21) Appl. No.: 11/367,877

(22) Filed: Mar. 2, 2006

Related U.S. Application Data
(63) Continuation-in-part of application No. 10/335,753, filed on Jan. 2, 2003, now Pat. No. 7,084,809.

(51) Int. Cl. G01S 3/02

(52) U.S. Cl. 342/463; 342/357.15

(57) ABSTRACT

For position determination with peer-to-peer communication, a target terminal broadcasts a request for assistance in determining its position. At least one ranging terminal receives the request. Each ranging terminal sends a response with a time of arrival (TOA) measurement for the request and the position of the ranging terminal. For two-way peer-to-peer, the target terminal receives at least one response from the at least one ranging terminal, obtains a TOA measurement for each response, estimates the distance to each ranging terminal based on the TOA measurement for the request and/or the TOA measurement for the response, and computes a position estimate for itself based on the estimated distance and the position for each ranging terminal. For one-way peer-to-peer, a network entity receives at least one response from the at least one ranging terminal, computes a position estimate for the target terminal, and sends the position estimate to the target terminal.

### CROSS-REFERENCE TO RELATED APPLICATIONS

The present application is a continuation-in-part of U.S. patent application Ser. No. 10/335,753 filed on Jan. 2, 2003, entitled, “Apparatus and Method of Position Determination Using Shared Information” assigned to the assignee herein and incorporated herein by reference.

### BACKGROUND

1. Field

The present disclosure relates generally to communication, and more specifically to techniques for performing position determination in a wireless communication network.

2. Background

It is often desirable, and sometimes necessary, to know the position of a wireless user. For example, an enhanced 911 (E911) wireless service promulgated by the Federal Communications Commission (FCC) requires the position of a terminal (e.g., a cellular phone) to be provided to a Public Safety Answering Point (PSAP) each time a 911 call is made from the terminal. In addition to the FCC mandate, various applications may use the position of a terminal to provide value-added features and possibly generate additional revenues.

In general, an estimate of the position of a terminal may be derived based on (1) the distances or ranges from the terminal to a sufficient number of transmitters, e.g., three or more transmitters, and (2) the known positions of these transmitters. Each transmitter may be a satellite or a base station in a wireless communication network. The distance to each transmitter and/or the position of each transmitter may be ascertained based on a signal sent by the transmitter.

In many instances, a terminal may not be able to receive a sufficient number of signals needed to compute a position estimate for itself. The inability to receive the required number of signals may be due to obstructions and artifacts in the environment, limited capabilities of the terminal, and so on. Nevertheless, it may be desirable to derive a position estimate for the terminal in these instances.

There is therefore a need in the art for techniques to perform position determination when an insufficient number of signals from satellites and base stations are available.

### SUMMARY

Techniques for performing position determination with peer-to-peer communication are described herein. These techniques can provide a position estimate for a terminal even if an insufficient number of signals from satellites and base stations are available. When an insufficient number of high-quality measurements is available, the techniques may be used to augment these measurements in order to derive a high quality position estimate.

In an embodiment of position determination with peer-to-peer communication, a target terminal desires to locate its position and broadcasts a request for assistance in determining its position. At least one ranging terminal capable of providing the requested assistance receives the request from the target terminal. Each ranging terminal sends a response with ranging information suitable for determining a position estimate for the target terminal. For example, the ranging information from each ranging terminal may include (1) a time of arrival (TOA) measurement made by that ranging terminal for the request sent by the target terminal, (2) the position of the ranging terminal, (3) received signal strength indicator (RSSI), and/or (4) other information. Each ranging terminal may send its response to the target terminal or to a network entity, e.g., a location server such as a Position Determining Entity (PDE) or a Serving Mobile Location Center (SMLC) that is capable of computing a position estimate for the target terminal. The RSSI measurement together with the transmit power may be used to estimate the distance (or range) between the transmitter and the receiver.

In an embodiment, the target terminal receives at least one response from the at least one ranging terminal. The target terminal may obtain a TOA measurement for each response, estimate the distance to each ranging terminal based on the TOA measurement for the request and/or the TOA measurement for the response, and compute a position estimate for itself based on the estimated distance and the position for each ranging terminal. In another embodiment, the network entity receives at least one response from the at least one ranging terminal, computes a position estimate for the target terminal, and sends the position estimate to the target terminal.

Various aspects and embodiments of the invention are described in further detail below.

### BRIEF DESCRIPTION OF THE DRAWINGS

The features and nature of the present invention will become more apparent from the detailed description set forth below when taken in conjunction with the drawings in which like reference characters identify correspondingly throughout.

FIG. 1 shows a wireless multiple-access communication network.

FIG. 2 shows position determination with two-way peer-to-peer communication.

FIG. 3 shows a transmission timeline for a ranging request and a response.

FIG. 4 shows derivation of a position estimate for a target terminal.

FIG. 5 shows position determination with one-way peer-to-peer communication.

FIG. 6 shows position determination with sector-based two-way peer-to-peer communication.

FIG. 7 shows a process performed by a target terminal.

FIG. 8 shows a process performed by a ranging terminal.

FIG. 9 shows a process performed by a PDE.

FIG. 10 shows a block diagram of a target terminal, a ranging terminal, a base station, and a PDE.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

The position determination techniques described herein may be used for various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), and so on. cdma2000 covers IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be used for any combination of WWAN, WLAN and/or WPAN.

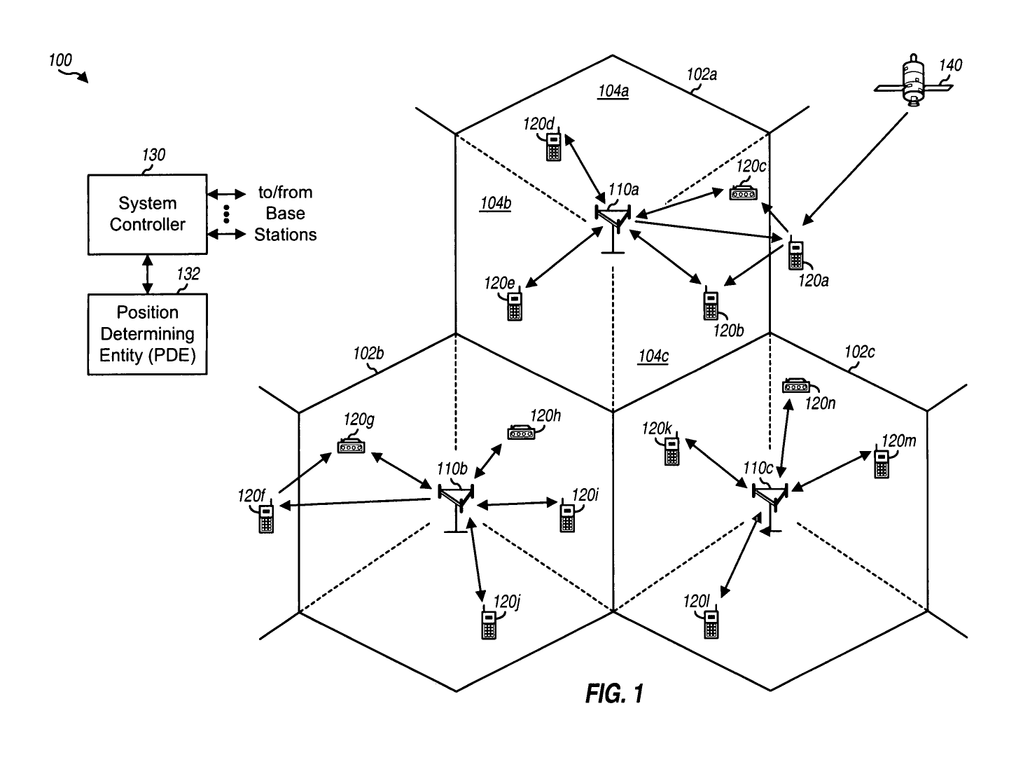

FIG. 1 shows a wireless multiple-access communication network 100. Network 100 may be a cellular network such as a cdma2000 network that implements IS-2000, IS-95 and/or IS-856 or a Universal Mobile Telecommunication System (UMTS) network that implements W-CDMA. Network 100 includes multiple base stations 110, with each base station providing communication coverage for a particular geographic area 102. A base station is generally a fixed station that communicates with the terminals. A base station may also be called an access point, a Node B, a beacon, or some other terminology. The term “cell” can refer to a base station and/or its coverage area depending on the context in which the term is used. The base stations may have coverage areas of different sizes and shapes, which may be determined by various factors such as terrain, obstructions, and so on. To improve system capacity, a base station coverage area may be partitioned into multiple smaller areas, e.g., three smaller areas 104a, 104b, and 104c. Each smaller area is served by a respective base transceiver subsystem (BTS). The term “sector” can refer to a BTS and/or its coverage area depending on the context in which the term is used. For a sectorized cell, the BTSs for all sectors of that cell are typically co-located within the base station for the cell.

The techniques described herein may be used for networks with sectorized cells as well as networks with un-sectorized cells. For clarity, much of the description below is for a cellular network with sectorized cells. For simplicity, in the following description, the term “base station” generically refers to a fixed station that serves a sector as well as a fixed station that serves a cell.

A system controller 130 couples to base stations 110 and provides coordination and control for these base stations. System controller 130 may be a single network entity or a collection of network entities. For example, system controller 130 may include a Base Station Controller (BSC), a Mobile Switching Center (MSC), a Radio Network Controller (RNC), a Packet Data Serving Node (PDSN), and/or some other network entity. A Position Determining Entity (PDE) 132 supports position determination for the terminals. For example, PDE 132 may provide assistance data used by the terminals to make ranging measurements. As used herein, a ranging measurement may be a TOA measurement, an observed time difference (OTD) measurement, a time difference of arrival (TDOA) measurement, an angle or arrival (AOA) measurement, received signal strength indicator (RSSI), round trip delay (RTD), and so on. These various types of ranging measurement are known in the art. PDE 132 may also compute position estimates for the terminals based on ranging measurements provided by the terminals and/or the base stations.

Terminals 120 are typically dispersed throughout network 100, and each terminal may be fixed or mobile. A terminal may also be called a mobile station, an access terminal, user equipment, or some other terminology. A terminal may be a wireless device, a cellular phone, a wireless modem, a wireless module, a personal digital assistant (PDA), and so on. A terminal may communicate with zero, one, or multiple base stations on the forward and/or reverse links at any given moment. A terminal may also communicate peer-to-peer with another terminal. A terminal may also receive signals from satellites 140, which may be from Global Positioning System (GPS), Galileo and/or other satellite positioning or communication systems. In general, a terminal may communicate directly with network 100 if good received signal quality can be achieved for both the forward and reverse links. A terminal may communicate indirectly with network 100, via peer-to-peer communication with at least one other terminal, if the required received signal quality is not achieved for one or both of the links.

In the description herein, a peer-to-peer (PTP) terminal is a terminal that can communicate peer-to-peer with another terminal. A target terminal is a PTP terminal whose position is being determined. A ranging terminal is a PTP terminal that communicates peer-to-peer with a target terminal and supports position determination for the target terminal.

1. Position Determination with One-Way and Two-Way Peer-to-Peer Communication

A network may support one-way and/or two-way peer-to-peer communication. In one embodiment of one-way peer-to-peer communication, a PTP terminal communicates peer-to-peer with another PTP terminal on only one link (e.g., the reverse link) and may further communicate with the network on the other link (e.g., the forward link). In another embodiment of one-way peer-to-peer communication, a PTP terminal communicates peer-to-peer with another PTP terminal on only one link and may communicate with the network on both the forward and the reverse links. For two-way peer-to-peer communication, a PTP terminal communicates peer-to-peer with another PTP terminal on both links. A target terminal may obtain a position estimate using one-way or two-way peer-to-peer communication.

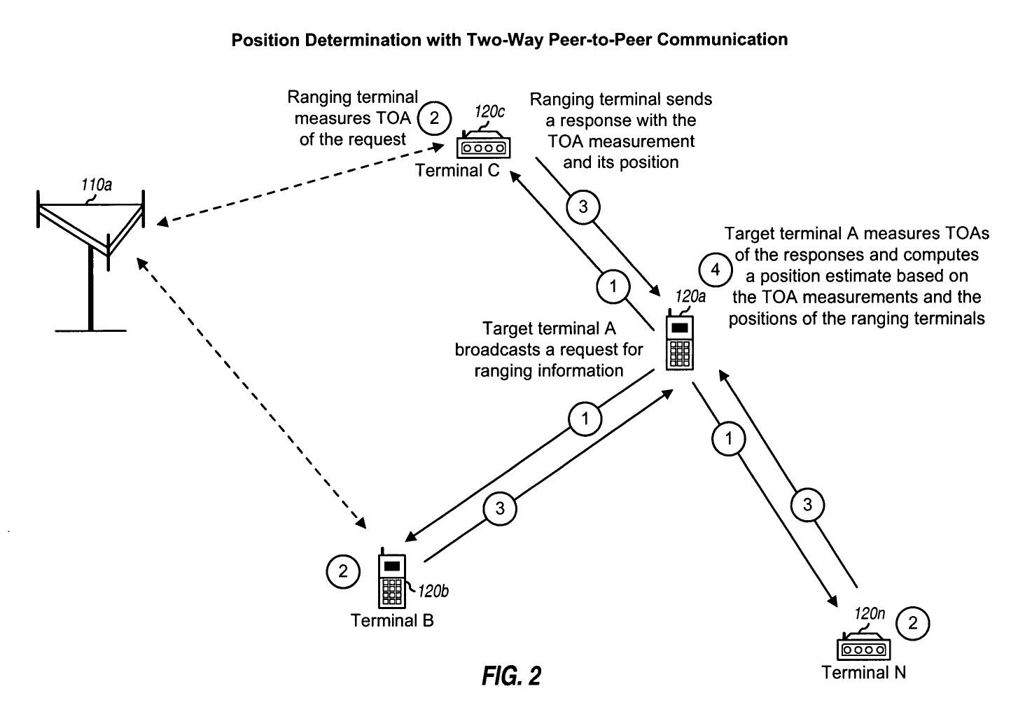

FIG. 2 shows an embodiment of position determination with two-way peer-to-peer communication. Terminals 120a, 120b, 120c and 120n are also referred to as terminals A, B, C and N, respectively. For this embodiment, target terminal A desires to locate its position or desires assistance in locating itself and broadcasts a request for ranging information (step 1). This request includes an indication of when the request was sent based on the timing of target terminal A. This indication may be either explicit or implicit, as described below. Ranging terminals B, C and N receive the request from target terminal A. Each ranging terminal measures the time of arrival (TOA) of the request based on the timing of that ranging terminal (step 2). Each ranging terminal then sends a response to target terminal A (step 3). In an embodiment, the response from each ranging terminal includes (1) the TOA measurement made by that ranging terminal for the request sent by target terminal A, (2) the position of the ranging terminal, and (3) an indication of when the response was sent, which may be explicit or implicit. The ranging terminals may send their responses at different times (e.g., in randomly selected frames or time slots) in order to avoid colliding with one another at target terminal A.

Target terminal A receives the responses from ranging terminals B, C and N. Target terminal A measures the time of arrival of the response from each ranging terminal based on the timing of the target terminal (step 4). Target terminal A then estimates the distance to each ranging terminal based on (1) the TOA measurement made by that ranging terminal for the request sent by the target terminal and (2) the TOA measurement made by the target terminal for the response sent by the ranging terminal (also step 4). Target terminal A then derives a position estimate for itself based on the estimated distances to ranging terminals B, C and N and the positions of these ranging terminals (also step 4).

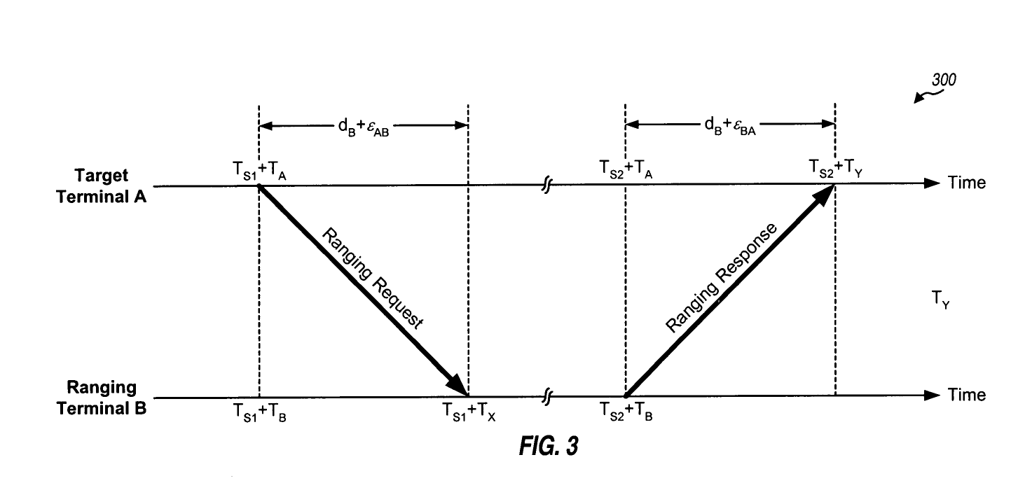

FIG. 3 shows a transmission timeline for the ranging request sent by target terminal A and the response sent by ranging terminal B. Each terminal maintains a time base that may be locked to system time, which is the time base of network 100. The time base for each terminal may be determined by, and locked to, a pilot received from a base station. The time base for each terminal may be offset from system time by an amount corresponding to the propagation delay between the base station and the terminal. For the example shown in FIG. 3, the timing offset for target terminal A is denoted as TA, and the timing offset for ranging terminal B is denoted as TB.

The transmission timeline for network 100 may be divided into frames, with each frame having a predetermined duration, e.g., 10 milliseconds (ms). Because of the timing offsets, in terms of absolute time, a given frame may start at time T_{S1}, in system time, at time T_{S1}+T_{A} for target terminal A, and at time T_{S1}+T_{A} for ranging terminal B. Target terminal A may send the ranging request at time T_{S1}+T_{A}, which is the start of the frame based on the timing of terminal A. The time at which the request is sent may be known by the ranging terminals and may be implicitly sent in the request. The distance between target terminal A and ranging terminal B is denoted as d_{B}, which may be given in units of time (seconds) or distance (meters). Ranging terminal B receives the request at time T_{S1}+T_{X}, which is d_{B}+ε_{AB} seconds from the time T_{S1}+T_{A} at which the request was sent, where ε_{AB} represents measurement error. Ranging terminal B may determine the TOA of the request based on the time when the request was received, T_{S1}+T_{X}, and the time when the request was sent, T_{S1}+T_{B}, as follows:
TOA_{AB}=(T_{S1}+T_{X})−(T_{S1}+T_{B})=T_{X}−T_{B}=d_{B}+T_{A}−T_{B}+ε_{AB}, Eq (1)
where TOA_{AB} is the TOA for the request sent by target terminal A to ranging terminal B,
T_{X} and T_{B} are based on the timing of ranging terminal B, and
ε_{AB} is a measurement error for TOA_{AB}, which may include excess delay due to non line-of-sight signal propagation between the two terminals.

Ranging terminal B sends the response at time T_{S2}+T_{B}, which is the start of the frame in which the response is sent based on the timing of terminal B. The time at which the response is sent may be known by the target terminal and may be implicitly sent in the response. Target terminal A receives the response at time T_{S2}+T_{Y}, which is d_{B}+ε_{BA} seconds from the time T_{S2}+T_{B} when the response was sent, where ε_{BA} represents measurement error. Target terminal A may determine the TOA of the response based on the time when the response was received, T_{S2}+T_{Y}, and the time when the response was sent, T_{S2}+T_{Y}, as follows:
TOA_{BA}=(T_{S2}+T_{Y})−(T_{S2}+T_{A})=T_{Y}−T_{A}=d_{B}+T_{B}−T_{A}+ε_{BA}, Eq (2)
where TOA_{BA} is the TOA for the response sent by ranging terminal B to target terminal A,
T_{Y} and T_{A} are based on the timing of target terminal A, and
ε_{BA} is a measurement error for TOA_{BA}, which may include excess delay due to non line-of-sight signal propagation between the two terminals.

Target terminal A obtains TOA_{AB} from the response sent by ranging terminal B and measures TOA_{BA} based on the response. Target terminal A may then estimate the distance between terminals A and B, as follows:
\hat{d}_{B}=0.5×(TOA_{AB}+TOA_{BA})=d_{B}+0.5×(ε_{AB}+ε_{BA}), Eq (3)
where \hat{d}_{B} is the estimated distance between terminals A and B. Equation (3) indicates that the timing offsets T_{A} and T_{B} for terminals A and B, respectively, are canceled in the estimated distance \hat{d}_{B}. However, the estimated distance includes the measurement errors and non line-of-sight delays ε_{AB} and ε_{BA}, which are not removed.

For the embodiment shown in FIG. 2, the target terminal estimates the distance to each ranging terminal based on a TOA measurement for the request and a TOA measurement for the response from that ranging terminal. In another embodiment, the target terminal estimates the distance to each ranging terminal based on the TOA measurement for the response from that ranging terminal and information indicative of the timing offset for the ranging terminal. The timing offset T_{A} for the target terminal is common in the TOA measurements for the responses from all ranging terminals and may be accounted for with an extra TOA measurement. In yet another embodiment, each ranging terminal estimates the distance to the target terminal based on its TOA measurement for the request and sends the estimated distance back to the target terminal. In general, the distance between the target terminal and each ranging terminal may be estimated by various entities (e.g., a terminal or a network entity) and based on various measurements and pertinent information. As an example, a round trip delay measurement may be used where RTD is equal to the sum of TOA_{AB}, TOA_{BA} and RxTx. RxTx is the internal delay of ranging terminal B and is equivalent to the time period between the time when the request is received and the time when the response is sent back to target terminal A: (T_{S2}+T_{B})−(T_{S1}+T_{X}).

Target terminal A may obtain any number of responses from any number of ranging terminals, which may be located any where in the network. Target terminal A may estimate the distance to each ranging terminal based on the response received from that ranging terminal. Target terminal A may then derive a position estimate for itself based on the estimated distances for all ranging terminals and their positions.

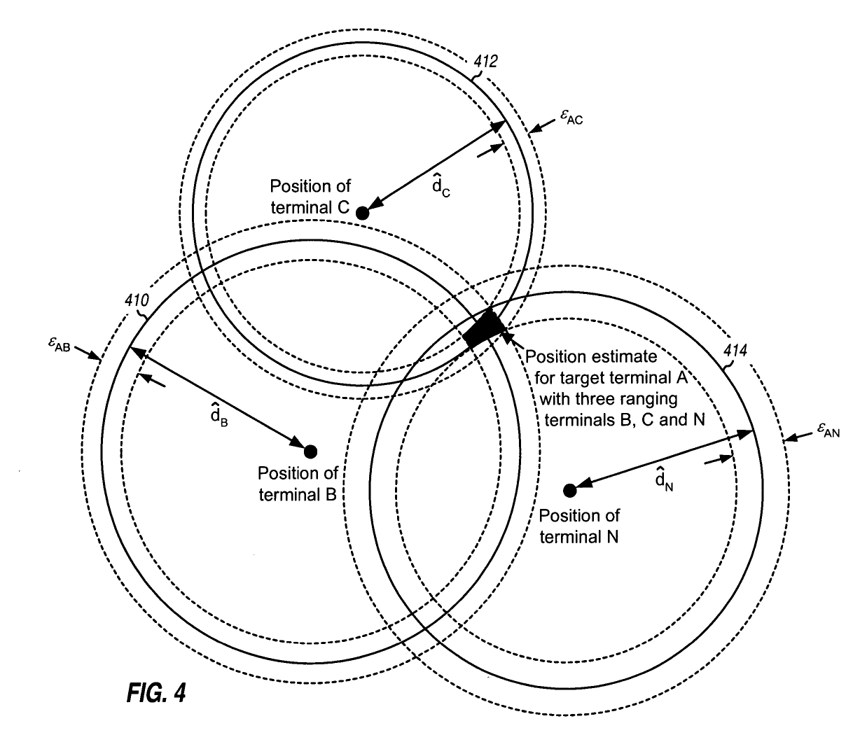

FIG. 4 shows an embodiment for determining a position estimate for target terminal A. The position of each ranging terminal may be plotted as a point on a 2-dimensional (2-D) plot. For each ranging terminal i, a circle with solid line may be drawn having (1) a center located at the known position of terminal i and (2) a radius of \hat{d}ᵢ, which is the estimated distance from target terminal A to terminal i. The circle for each ranging terminal i has a width of ε_{Ai}, which is represented by two concentric circles with dashed lines. ε_{Ai} is an uncompensated residual error in the distance estimate \hat{d}ᵢ for terminal i. In FIG. 4, circles 410, 412 and 414 are drawn for ranging terminals B, C and N, respectively.

If only one ranging terminal is available, then the position of that ranging terminal may be provided as the position estimate for target terminal A, and the circle for that ranging terminal may be provided as the uncertainty in the position estimate, which is also called the error criteria. For example, if target terminal A receives only one response from ranging terminal B, then the position of terminal B may be provided as the position estimate for terminal A, and the area within circle 410 may be provided as the uncertainty in the position estimate.

If two ranging terminals are available, then the circles for these two terminals intersect at two points, and there is ambiguity as to which one of the two points is the position of the target terminal. A line may be drawn between these two points, and a point at the center of this line may be provided as the position estimate for the target terminal. The overlapping area for the two circles may be provided as the uncertainty in the position estimate.

If three ranging terminals are available, then the circles for these three terminals intersect at various points. A point that is a minimum mean square distance to the circumferences of the three circles may be provided as the position estimate for the target terminal. The square root of the sum of the mean square errors may be provided as the uncertainty in the position estimate. Alternatively, the intersection area for the three intersecting circles may be provided as the uncertainty in the position estimate, as shown in FIG. 4.

In general, a position estimate for the target terminal may be computed using a least mean square (LMS) algorithm or some other algorithm. The LMS algorithm performs a number of iterations to arrive at a final solution for the position estimate. The LMS algorithm and other algorithms are known in the art.

In an embodiment, which is shown in FIG. 2, the target terminal receives ranging information from the ranging terminals and computes a position estimate for itself. In another embodiment, the target terminal and/or the ranging terminals forward the ranging information to PDE 132. PDE 132 then computes a position estimate for the target terminal and, if needed, returns the position estimate to the target terminal. Some other network entity may also compute the position estimate for the target terminal. In another example, the position estimate is provided to a network entity or a terminal interested in the location of the target terminal.

In an embodiment, which is shown in FIG. 2, the target terminal does not send acknowledgments (ACKs) for the responses sent by the ranging terminals. In another embodiment, the target terminal waits a predetermined duration for the responses from the ranging terminals and sends an ACK for each response or broadcasts a single ACK for all responses. The target terminal may not receive a response sent by a given ranging terminal for various reasons such as (1) insufficient transmit power for the response and/or (2) collision with another response sent by another ranging terminal. The ranging terminals may resend their responses if the ACK(s) are not received. For all embodiments, the target terminal may rebroadcast the request if no responses are received from any ranging terminal within a predetermined time period.

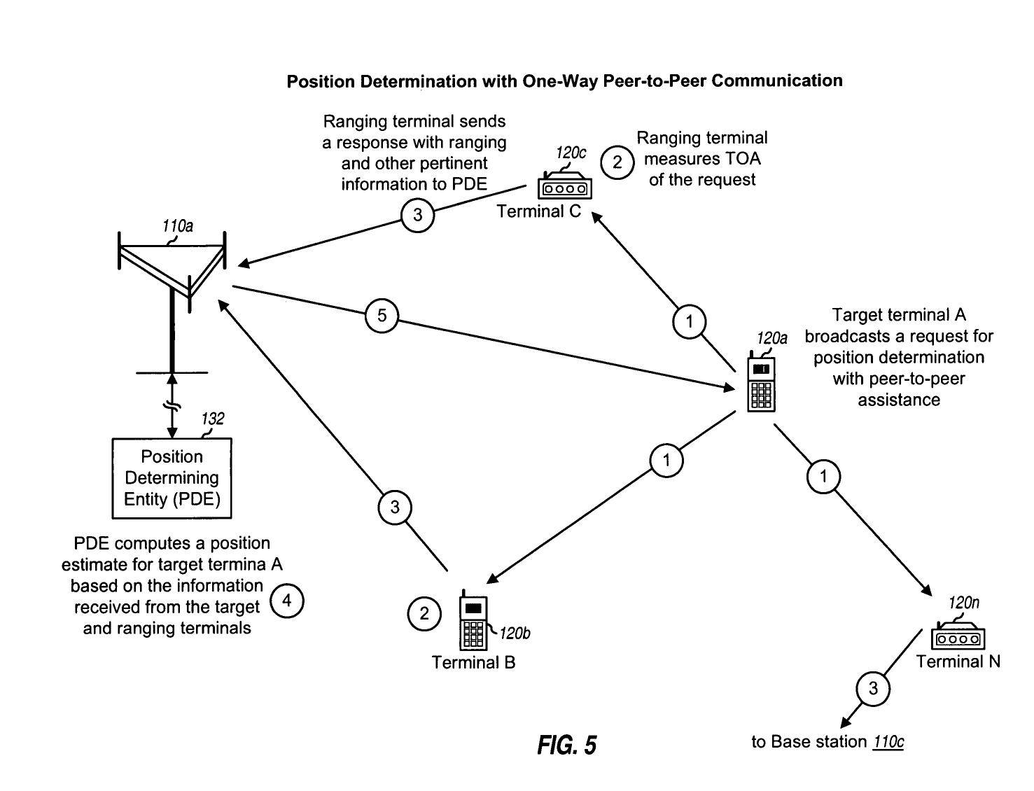

FIG. 5 shows an embodiment of position determination with one-way peer-to-peer communication. Target terminal A desires to locate its position and transmits a request for position determination with peer-to-peer assistance (step 1). This request asks the ranging terminals to measure the TOA of the request and to forward ranging information to PDE 132. This request may include (1) the identity of target terminal A and, optionally, (2) an indication of when the request was sent based on the timing of target terminal A. For example, the request may be sent at the start of a frame and may include the identity of the base station from which target terminal A obtains its timing. The base station identity (BSID) may be used to estimate the timing offset T_{A} of target terminal A. In the example, when the timing offset T_{A} of target terminal A is not needed for a given application, the location of the target terminal may be determined without explicitly solving for T_{A}. Target terminal A may also send to PDE 132 (either via base station 10a or via the ranging terminals and base station 110a) the BSID and any ranging measurements that target terminal A may have obtained for base stations, satellites, and/or other transmitters.

Ranging terminals B, C and N receive the request from target terminal A. Each ranging terminal measures the TOA of the request based on the timing of that ranging terminal, e.g., as shown in equation (1) (step 2). Each ranging terminal then sends a response to PDE 132 via its serving base station (step 3). The response from each ranging terminal may include (1) the identification of the ranging terminal, (2) the TOA measurement made by the ranging terminal for the request sent by target terminal A, (3) the position of the ranging terminal, (4) the BSID of the base station from which the ranging terminal obtains its timing, which may be used to estimate the timing offset Tᵢ for the ranging terminal, (5) any ranging measurements that ranging terminal may have obtained for base stations, satellites, and/or other transmitters, and (6) the information sent in the request. A ranging terminal may also estimate its timing offset, remove the estimated timing offset from its TOA measurement, and provide a corrected TOA measurement to PDE 132. A ranging terminal may also send information to PDE 132 to allow the PDE to compute a position estimate for the ranging terminal. Raw measurements from the ranging and target terminals may be used to enhance relative position determination. For example, the position of a target terminal may be determined with respect to the positions of the ranging terminals.

PDE 132 receives the responses from the ranging terminals and possibly additional ranging information from target terminal A. PDE 132 then estimates the distance between target terminal A and each ranging terminal based on (1) the TOA measurement made by that ranging terminal and (2) the timing of the ranging terminal and/or the timing of the target terminal, if available (step 4). PDE 132 may estimate the timing offset for each terminal based on the BSID of the base station from which that terminal obtains its timing. PDE 132 may then remove the estimated timing offset for each terminal from the TOA measurement. Since the timing offset T_{A} for target terminal A is common to all peer-to-peer TOA measurements, an extra TOA measurement can account for an unknown timing offset TA, which would not need to be estimated and canceled from the TOA measurements made by the ranging terminals. The unknown timing offset T_{A} is indicative of the distance between the target terminal and the reference base station. Thus, the PDE may add this constraint when calculating the position based on the LMS, LSF or other algorithm.

PDE 132 derives a position estimate for target terminal A based on (1) the estimated distances between target terminal A and the ranging terminals, (2) the positions of the ranging terminals, (3) ranging measurements made by target terminal A for other transmitters, if any, (4) the positions of these other transmitters and (5) the locations of the base stations from which ranging terminals B, C and N and optionally target terminal A derive their timing (also step 4). PDE 132 then sends the position estimate to target terminal A, if needed (step 5). PDE 132 may send the position estimate to base station 110a, which may then send the position estimate directly to target terminal A, as shown in FIG. 5. Alternatively, base station 110a may send the position estimate to one or more ranging terminals, which may then forward the position estimate to target terminal A.

For the embodiments shown in FIGS. 2 and 5, a position estimate for the target terminal may be computed based solely on TOA measurements made by the target and/or ranging terminals and the positions of the ranging terminals, as described above. The TOA measurements may include errors due to multipath, timing stability, and/or other factors. The measurement errors may be mitigated by performing multiple measurements.

The position estimate for the target terminal is affected by the accuracy of the positions of the ranging terminals. In an embodiment, the target terminal can request the ranging terminals to provide their positions with a desired accuracy or uncertainty. The ranging terminals may then determine their positions to within the desired uncertainty and return their positions to the target terminal. The positions of the ranging terminals and the uncertainties in these positions may be taken into account when computing the position estimate for the target terminal.

The accuracy of the position estimate for the target terminal generally improves with the number of ranging terminals making ranging measurements for the target terminal. However, in an area with a dense concentration of ranging terminals, there may be too many responses for the request sent by the target terminal. The number of responses may be controlled by soliciting responses from only certain ranging terminals. In an embodiment, the ranging terminals are selected randomly to provide responses. For example, a hashing function may be used to select every N-th ranging terminals based on the unique identifiers for these terminals, where N may be any integer value. In another embodiment, ranging terminals within a predetermined distance of the target terminal are selected to provide responses. Similarly, ranging terminals delivering the optimum geometry relative to the target terminal or having desirable signal characteristics (e.g., SNR, SIR, Ec/Io, and so on) may be selected for ranging. In yet another embodiment, one or more classes of ranging terminals are selected to provide responses. For example, ranging terminals that are stationary or fixed, terminals that are powered by alternating current (AC), and/or some other classes of terminals may be selected to provide responses. In yet another embodiment, the ranging terminals send their responses after waiting a particular duration. The wait duration for each ranging terminal may be a pseudo-random duration. The wait duration for each ranging terminal may also be computed based on one or more factors such as, e.g., the estimated distance to the target terminal, the accuracy of the position of the ranging terminal, and so on. For each ranging terminal, if an ACK is received from the target terminal prior to expiration of the wait duration, then the ranging terminal does not send a response. The responses from the ranging terminals may also be controlled in other manners.

In general, a position estimate for the target terminal may be computed based on ranging measurements for a sufficient number of transmitters, which may be of the same or different types, and the positions of these transmitters. The position estimate for the target terminal may be computed based on (1) ranging measurements made by the target terminal for ranging terminals, base stations, satellites, and/or other transmitters (e.g., broadcast stations, WLAN terminals, and so on), (2) ranging measurements made by the ranging terminals, base stations, and/or other receivers for the target terminal, or (3) any combination thereof. Ranging measurements with higher reliability (e.g., measurements for satellites) may be given greater weight in the computation of the position estimate.

The target terminal may obtain assistance data from the wireless network. The assistance data may indicate, e.g., the location of each base station of interest, an almanac containing the location of the satellites, timing information for the base stations and/or satellites, and so on. The target terminal may use the assistance data to select and make ranging measurements for the base stations and satellites and/or to compute a position estimate for itself.

2. Sector-Based and Global-Based Message Forwarding

Position determination with peer-to-peer communication, e.g., as shown in FIGS. 2 and 5, may be performed with a sector-based scheme or a global-based scheme. For the sector-based scheme, the target terminal transmits a request to ranging terminals within a specific sector. For the global-based scheme, the target terminal broadcasts a request to ranging terminals in the network. The sector-based and global-based schemes may be used for one-way and two-way peer-to-peer communication.

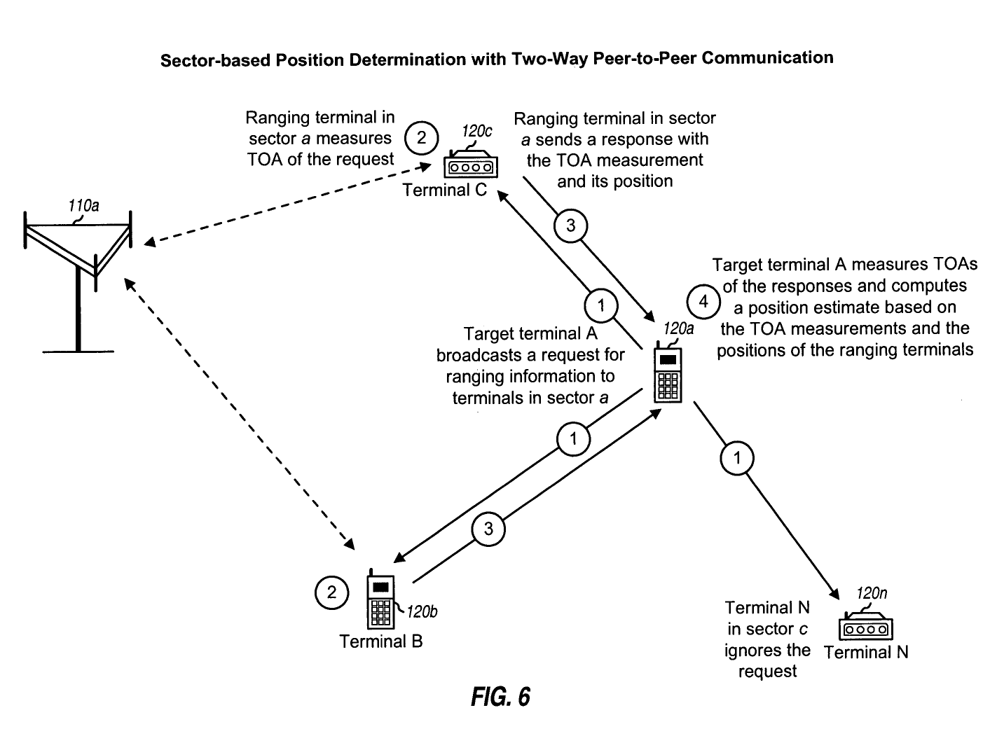

FIG. 6 shows an embodiment of position determination with sector-based two-way peer-to-peer communication. Target terminal A transmits a request for ranging information to terminals in a designated sector a, which may be the sector that is received strongest by terminal A. The request may be transmitted to sector a by using a specific pseudo-random number (PN) code, a specific scrambling code, and/or some other unique identifier assigned to sector a. For the sector-based scheme, each ranging terminal listens for requests transmitted to its sector. Terminals B and C are located in sector a, recognize that the request transmitted by terminal A is for sector a, and process the request. Terminal N is located in sector c and either does not receive the request sent by terminal A or recognizes that the request is broadcast to another sector. In any case, terminal N ignores the request from terminal A.

In an embodiment, target terminal A transmits its request to only one sector, e.g., the sector received strongest by terminal A. In another embodiment, target terminal A transmits its request to one or more sectors, e.g., until terminal A receives a sufficient number of responses. For example, target terminal A may first transmit the request to the strongest received sector, then to the next strongest received sector if an insufficient number of responses is received, and so on. In another example, target terminal A may request additional ranging measurements from terminals in another sector (which may belong to a different base station) if the geometry of the received ranging measurements is not sufficient to derive a position estimate of required quality of service. Other selection criteria may be used to select the ranging terminals for the purpose of target terminal position determination.

FIG. 2 shows an embodiment of position determination with global-based two-way peer-to-peer communication. For this embodiment, target terminal A broadcasts a request to ranging terminals in the network, e.g., using a global PN code. For this embodiment, each ranging terminal listens for requests broadcast using the global PN code. Ranging terminals B, C and N in sectors a and c receive the request from target terminal A and perform processing as described above.

In an embodiment, the network supports either the sector-based or global-based scheme. In another embodiment, the network supports both sector-based and global-based schemes. For this embodiment, the target terminal may first attempt sector-based position determination and may broadcast a request, e.g., to the strongest received sector. If a position estimate cannot be computed or is not sufficiently accurate (e.g., does not meet the quality of service), then the target terminal may attempt global-based position determination and may then broadcast the request to all sectors, e.g., using the global PN code.

3. Message Transmission

Network 100 may utilize frequency division duplexing (FDD), which allocates two separate frequency bands for the forward and reverse links. A terminal is typically designed to transmit on the reverse link to a base station and to receive on the forward link from the base station. Two PTP terminals can communicate one-way peer-to-peer if one PTP terminal can transmit on the forward link or receive on the reverse link. Two PTP terminals can communicate two-way peer-to-peer if both PTP terminals can transmit on the forward link, both PTP terminals can receive on the reverse link, or one PTP terminal can transmit on the forward link and receive on the reverse link. In an embodiment, a target terminal transmits a request on the forward link. The target terminal may cause excessive interference on the forward link to other terminals and may reduce its transmit power when located far from the base station. In another embodiment, a target terminal transmits a request on the reverse link. The target terminal may cause excessive interference on the reverse link at the base station and may reduce its transmit power when located close to the base station. In an embodiment, the target terminal determines an open loop power estimate, which is the transmit power for an access channel in the network. The target terminal may then transmit the request at a power level determined by the open loop power estimate, e.g., X dB lower than the open loop power estimate, where X is selected to provide good performance.

In an embodiment, a target terminal may broadcast a request at any time. The ranging terminals may continuously listen for requests from the target terminals when these ranging terminals are not performing other functions. In another embodiment, a target terminal may broadcast a request in designated time periods. The ranging terminals may listen for requests from the target terminals only during these time periods.

A target terminal may broadcast a request using various random access schemes such as a slotted aloha random access scheme, a carrier sense multiple access (CSMA) scheme, and so on. In an embodiment, a target terminal broadcasts a request on an access channel available in the network. For example, the target terminal may send a request on a Reverse Access Channel (R-ACH) or a Reverse Enhanced Access Channel (R-EACH) in cdma2000. The ranging terminals may detect the request by processing the R-ACH or R-EACH in similar manner as the base stations. In another embodiment, a target terminal broadcasts a request on a Reverse Peer Enhanced Access Channel (R-PEACH), which is a physical channel used to support peer-to-peer communication. The R-PEACH may support one or more message formats and one or more data rates. For all embodiments, the target terminal transmits the request at a power level that does not cause excessive interference to other terminals.

In an embodiment of two-way peer-to-peer, a ranging terminal sends a response to the target terminal via the R-PEACH, R-ACH, R-EACH, or some other channel. In an embodiment of one-way peer-to-peer, a ranging terminal sends a response to a base station using the R-ACH, R-EACH, or some other channel.

4. Flow Diagrams

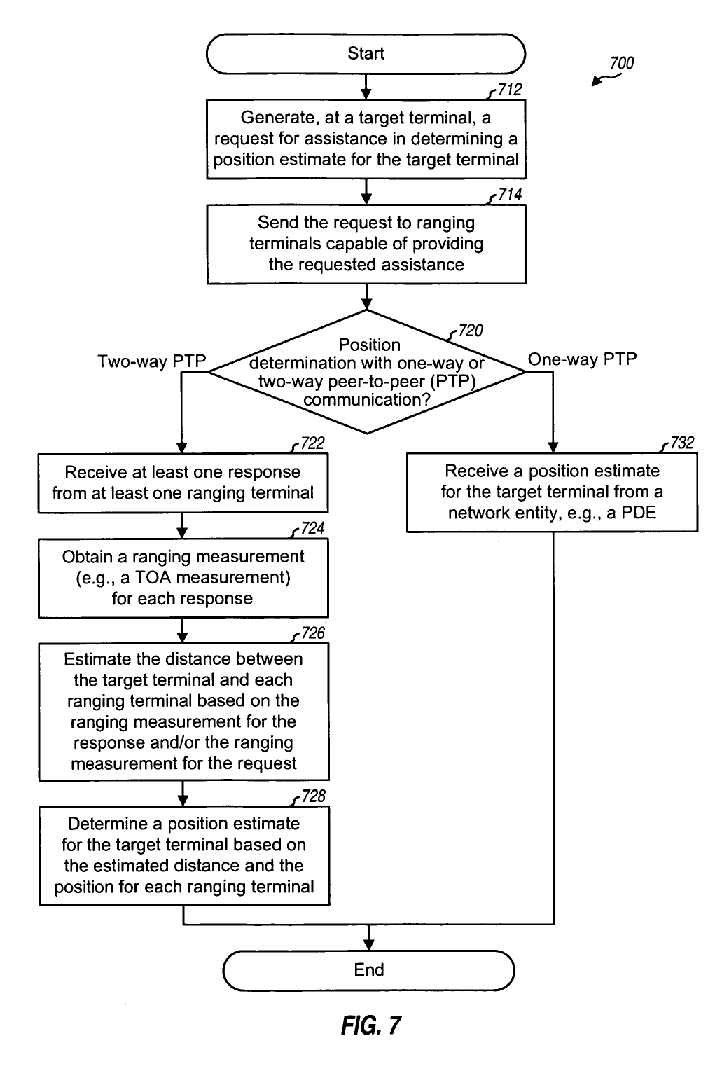

FIG. 7 shows an embodiment of a process 700 performed by a target terminal for position determination with peer-to-peer communication. The target terminal desires to locate its position and generates a request for assistance in determining a position estimate for itself (block 712). This request may (1) solicit for ranging information from the ranging terminals, (2) ask the ranging terminals to obtain ranging information for the target terminal and to forward the ranging information to a network entity (e.g., a PDE) capable of determining a position estimate for the target terminal, or (3) ask for other information and/or assistance suitable for position determination. The request may also include pertinent information as described above, which may be used by the network entity for position determination of the target terminal. The target terminal then sends the request to the ranging terminals capable of providing the requested assistance (block 714). The request may be sent to a specific sector, a group of sectors, or all sectors in the network.

For position determination with two-way peer-to-peer (PTP) communication, as determined in block 720, the target terminal receives at least one response from at least one ranging terminal (block 722). The response from each ranging terminal may include the position of the ranging terminal (or some identification information which can be associated with position) and a ranging measurement (e.g., a TOA measurement) made by the ranging terminal for the request sent by the target terminal. The target terminal may also obtain a ranging measurement (e.g., a TOA measurement) for each response (block 724). The target terminal may then estimate the distance between the target terminal and each ranging terminal based on (1) the ranging measurement made by the target terminal for the response from that ranging terminal and/or (2) the ranging measurement made by that ranging terminal for the request sent by the target terminal (block 726). The target terminal may then determine a position estimate for itself based on the estimated distance and the position for each ranging terminal (block 728). For position determination with one-way peer-to-peer communication, as determined in block 720, the target terminal may simply receive a position estimate for itself from the network entity (block 732)

Although not shown in FIG. 7 for simplicity, the target terminal may obtain ranging measurements for other transmitters, which may be base stations and/or satellites. The target terminal may (1) use these ranging measurements to compute the position estimate for itself or (2) send these measurements to the network entity for use to compute the position estimate for the target terminal. In addition, the ranging terminals may also obtain ranging measurements for other transmitters which may be base stations and/or satellites, and these ranging measurements may also be used to determine the position estimate of the target terminal.

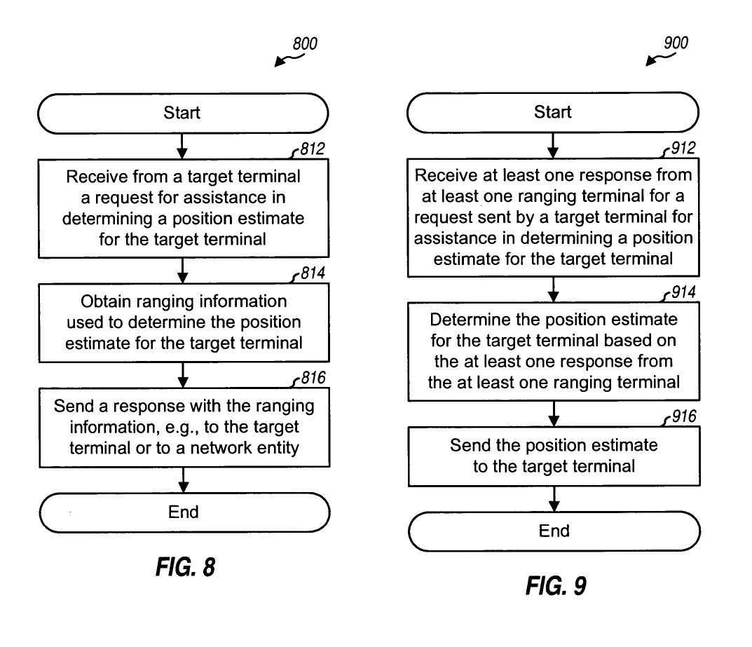

FIG. 8 shows an embodiment of a process 800 performed by a ranging terminal to support position determination with peer-to-peer communication. The ranging terminal receives from a target terminal a request for assistance in determining a position estimate for the target terminal (block 812). The ranging terminal obtains ranging information suitable for determining the position estimate for the target terminal (block 814). For example, the ranging terminal may obtain a TOA measurement for the request from the target terminal and may provide the TOA measurement for the request and the position of the ranging terminal as the ranging information. Alternatively, the ranging terminal may obtain an RSSI measurement for the request from the target terminal and may provide the RSSI measurement and the position of the ranging terminal as the ranging information. The ranging information may also include other information (e.g., a BSID) used to determine the timing offset at the ranging terminal. The ranging terminal sends a response with the ranging information to the target terminal or to a network entity (e.g., a PDE) (block 816).

FIG. 9 shows an embodiment of a process 900 performed by a network entity (e.g., a PDE) to support position determination with peer-to-peer communication. The network entity receives at least one response from at least one ranging terminal for a request sent by a target terminal for assistance in determining a position estimate for the target terminal (block 912). Each response contains ranging information to be used to determine the position estimate for the target terminal. The network entity determines the position estimate for the target terminal based on the at least one response from the at least one ranging terminal (block 914). For example, the network entity may estimate the distance between the target terminal and each ranging terminal based on a TOA measurement made by the ranging terminal. The network entity may estimate the timing offset of each terminal and may remove the timing offset from each affected measurement. The network entity may determine the position estimate for the target terminal based on (1) the estimated distance between the target terminal and each ranging terminal and (2) the position of each ranging terminal. The network entity may also obtain one or more additional ranging measurements for one or more other transmitters received by the target terminal and/or ranging terminals and may determine the position estimate for the target terminal based on these additional ranging measurements. In any case, the network entity sends the position estimate to the target terminal, if needed (block 916).

5. Block Diagrams

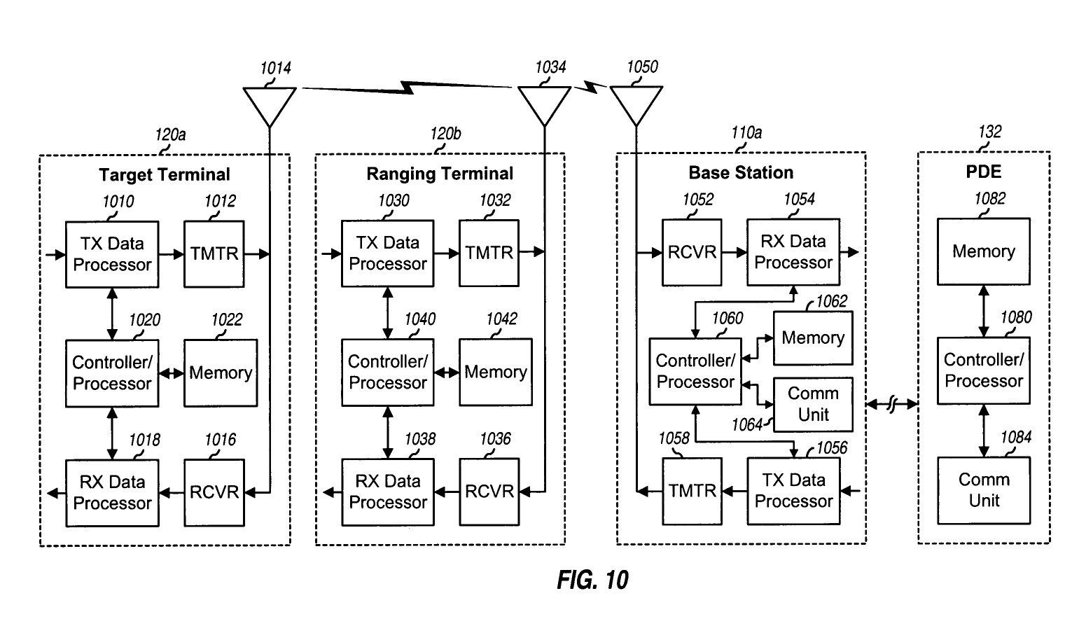

FIG. 10 shows a block diagram of target terminal 120a, ranging terminal 120b, base station 110a, and PDE 132. At target terminal 120a, a controller/processor 1020 issues a request for position determination with peer-to-peer communication. A transmit (TX) data processor 1010 receives the request, generates a request message, and provides data bits to be sent for the message. A transmitter (TMTR) 1012 conditions (e.g., converts to analog, amplifies, filters, and frequency upconverts) the data bits and generates a PTP signal, which is transmitted via an antenna 1014.

At ranging terminal 120b, an antenna 1034 receives the PTP signal from target terminal 120a and provides a received signal to a receiver (RCVR) 1036. Receiver 1036 conditions (e.g., filters, amplifies, frequency downconverts, and digitizes) the received signal and provides data samples. A receive (RX) data processor 1038 processes (e.g., descrambles, channelizes, demodulates, deinterleaves, and decodes) the data samples to recover the request message sent by target terminal 120a. Receiver 1036 and/or RX data processor 1038 may further determine the TOA of the request message. A TX data processor 1030 generates a response message for the request. The response message may contain different information depending on whether the response is being sent to target terminal 120a or PDE 132, as described above.

For position determination with two-way peer-to-peer communication, as shown in FIG. 2, a transmitter 1032 generates a PTP signal, which is transmitted via antenna 1034 to target terminal 120a. At target terminal 120a, the PTP signal from ranging terminal 120b is received by antenna 1014, conditioned by a receiver 1016, and processed by an RX data processor 1018 to recover the response message from ranging terminal 120b. Receiver 1016 and/or RX data processor 1018 may also determine the TOA of the response message. Controller/processor 1020 estimates the distance to ranging terminal 120b and possibly other ranging terminals and further computes a position estimate for target terminal 120a.

For position determination with one-way peer-to-peer communication, as shown in FIG. 5, transmitter 1032 generates an RL signal, which is transmitted via antenna 1034 to base station 10a. At base station 10a, the RL signal from ranging terminal 120b is received by an antenna 1050, conditioned by a receiver 1052, and processed by an RX data processor 1054 to recover the response message from ranging terminal 120b. A communication (Comm) unit 1064 forwards the response message to PDE 132. At PDE 132, a communication unit 1084 receives the response messages for all ranging terminals. A controller/processor 1080 computes a position estimate for target terminal 120a and forwards the position estimate to base station 110a. At base station 110a, the position estimate for target terminal 120a and other data to be sent on the forward link are processed by a TX data processor 1056 and conditioned by a transmitter 1058 to generate an FL signal, which is transmitted via antenna 1050. At target terminal 120a, the FL signal from base station 110a is received by antenna 1014 (not shown in FIG. 10), conditioned by receiver 1016, and processed by RX data processor 1018 to recover the position estimate sent by PDE 132. The position estimate may also be sent from PDE 132 to base station 110a, then to ranging terminal 120b, and then to target terminal 120a.

Controllers/processors 1020, 1040, 1060 and 1080 direct the operation of various units within terminals 120a and 120b, base station 110a, and PDE 132 respectively. Memories 1022, 1042, 1062 and 1082 store data and program codes for terminals 120a and 120b, base station 110a, and PDE 132 respectively.

For clarity, the description above assumes that the target terminal, the ranging terminals, and the base stations communicate using the same radio access technology (RAT). In general, any one or any combination of RATs may be used to support peer-to-peer communication. For example, the target and ranging terminals may communicate using a first RAT, and the ranging terminals and the base stations may communicate using a second RAT. Each RAT may be for WWAN or WLAN or WPAN. For example, the target and ranging terminals may communicate using IEEE 802.11x, Bluetooth, UWM, ZigBee, and so on. The ranging terminals and the base stations may communicate using cdma2000, W-CDMA, GSM, OFDM, and so on. The target and ranging terminals may each support one or multiple RATs.

The position determination techniques described herein may be implemented by various means. For example, these techniques may be implemented in hardware, firmware, software, or a combination thereof. For a hardware implementation, the processing units at a PTP terminal, a base station, or a network entity may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the techniques may be implemented with modules (e.g., procedures, functions, and so on) that perform the functions described herein. The software codes may be stored in a memory (e.g., memory 1022, 1042, 1062 or 1082 in FIG. 10) and executed by a processor (e.g., processor 1020, 1040, 1060 or 1080). The memory may be implemented within the processor or external to the processor.

Headings are included herein for reference and to aid in locating certain sections. These headings are not intended to limit the scope of the concepts described therein under, and these concepts may have applicability in other sections throughout the entire specification.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus comprising:
at least one processor configured to generate a request for assistance in determining a position estimate for a target terminal, to select at least one sector in a wireless network for sending the request, and to send the request to at least one ranging terminal located in the at least one sector and capable of providing the assistance; and
a memory coupled to the at least one processor.

2. The apparatus of claim 1, wherein the request solicits ranging information from the at least one ranging terminal, and wherein the position estimate is determined based on the ranging information.

3. The apparatus of claim 1, wherein the at least one processor is configured to receive at least one response from the at least one ranging terminal, and to determine the position estimate for the target terminal based on the at least one response.

4. The apparatus of claim 1, wherein the at least one processor is configured to receive at least one response from the at least one ranging terminal, to obtain a ranging measurement for each of the at least one response, to estimate a distance between the target terminal and each ranging terminal based on the ranging measurement for the response from the ranging terminal, and to determine the position estimate for the target terminal based on the estimated distance for each of the at least one ranging terminal.

5. The apparatus of claim 1, wherein the at least one processor is configured to receive at least one response from the at least one ranging terminal, wherein the response from each ranging terminal includes a position of the ranging terminal and a ranging measurement for the request, to obtain a ranging measurement for the response from each ranging terminal, to estimate a distance between the target terminal and each ranging terminal based on the ranging measurement for the request and the ranging measurement for the response from the ranging terminal, and to determine the position estimate for the target terminal based on the estimated distance and the position for each of the at least one ranging terminal.

6. The apparatus of claim 1, wherein the at least one processor is configured to send the request to a specific sector in a wireless network.

7. The apparatus of claim 1, wherein the at least one processor is configured to send the request to all sectors in a wireless network.

8. The apparatus of claim 1, wherein the request solicits the at least one ranging terminal to obtain ranging information for the target terminal and to forward the ranging information to a network entity capable of determining the position estimate for the target terminal.

9. The apparatus of claim 8, wherein the at least one processor is configured to receive the position estimate for the target terminal from the network entity.

10. The apparatus of claim 8, wherein the at least one processor is configured to send information indicative of a timing offset at the target terminal.

11. The apparatus of claim 8, wherein the at least one processor is configured to obtain at least one ranging measurement for at least one other transmitter, and to send the at least one ranging measurement to the network entity.

12. The apparatus of claim 1, wherein the at least one processor is configured to receive at least one response from the at least one ranging terminal, to obtain a ranging measurement for each of the at least one response, to obtain at least one additional ranging measurement for at least one other transmitter, and to determine the position estimate for the target terminal based on the at least one ranging measurement for the at least one response and the at least one additional ranging measurement for the at least one other transmitter.

13. The apparatus of claim 12, wherein the at least one processor is configured to obtain the at least one additional ranging measurement for at least one base station in a wireless network.

14. The apparatus of claim 12, wherein the at least one processor is configured to obtain the at least one additional ranging measurement for at least one satellite in a satellite positioning system.

15. The apparatus of claim 1, wherein the target terminal and the at least one ranging terminal are in a cellular network.

16. The apparatus of claim 1, wherein the at least one processor is configured to derive an open loop power estimate for an access channel in a cellular network, and to transmit the request at a power level determined by the open loop power estimate.

17. A method comprising:
generating, at a target terminal, a request for assistance in determining a position estimate for the target terminal;
selecting at least one sector in a wireless network for sending the request; and
sending the request to at least one ranging terminal located in the at least one sector and capable of providing the assistance.

18. The method of claim 17, further comprising:
receiving at least one response from the at least one ranging terminal;
obtaining a ranging measurement for each of the at least one response;
estimating a distance between the target terminal and each ranging terminal based on the ranging measurement for the response from the ranging terminal; and
determining the position estimate for the target terminal based on the estimated distance for each of the at least one ranging terminal.

19. The method of claim 17, further comprising:
receiving at least one response from the at least one ranging terminal, wherein the response from each ranging terminal includes a position of the ranging terminal and a ranging measurement made by the ranging terminal for the request;
obtaining a ranging measurement for the response from each ranging terminal;
estimating a distance between the target terminal and each ranging terminal based on the ranging measurement made by the ranging terminal for the request and the ranging measurement for the response from the ranging terminal; and
determining the position estimate for the target terminal based on the estimated distance and the position for each of the at least one ranging terminal.

20. An apparatus comprising:
means for generating, at a target terminal, a request for assistance in determining a position estimate for the target terminal;
means for selecting at least one sector in a wireless network for sending the request; and
means for sending the request to at least one ranging terminal located in the at least one sector and capable of providing the assistance.

21. The apparatus of claim 20, further comprising:
means for receiving at least one response from the at least one ranging terminal;
means for obtaining a ranging measurement for each of the at least one response;
means for estimating a distance between the target terminal and each ranging terminal based on the ranging measurement for the response from the ranging terminal; and
means for determining the position estimate for the target terminal based on the estimated distance for each of the at least one ranging terminal.

22. The apparatus of claim 20, further comprising:
means for receiving at least one response from the at least one ranging terminal, wherein the response from each ranging terminal includes a position of the ranging terminal and a ranging measurement made by the ranging terminal for the request;
means for obtaining a ranging measurement for the response from each ranging terminal;
means for estimating a distance between the target terminal and each ranging terminal based on the ranging measurement made by the ranging terminal for the request and the ranging measurement for the response from the ranging terminal; and
means for determining the position estimate for the target terminal based on the estimated distance and the position for each of the at least one ranging terminal.

23. An apparatus comprising:
at least one processor configured to receive from a target terminal a request for assistance in determining a position estimate for the target terminal, to obtain ranging information suitable for determining the position estimate for the target terminal, and to send a response with the ranging information; and
a memory coupled to the at least one processor.

24. The apparatus of claim 23, wherein the at least one processor is configured to obtain a ranging measurement for the request received from the target terminal, and to provide the ranging measurement and a position of the apparatus as the ranging information.

25. The apparatus of claim 23, wherein the at least one processor is configured to send the response to the target terminal.

26. The apparatus of claim 23, wherein the at least one processor is configured to send information indicative of a timing offset at the apparatus.

27. The apparatus of claim 23, wherein the at least one processor is configured to send the response to a network entity capable of determining the position estimate for the target terminal.

28. A method of comprising:
receiving at a ranging terminal a request for assistance in determining a position estimate for a target terminal;
obtaining ranging information suitable for determining the position estimate for the target terminal; and
sending a response with the ranging information.

29. The method of claim 28, wherein the obtaining the ranging information comprises
obtaining a ranging measurement for the request received from the target terminal, and
providing the ranging measurement and a position of the ranging terminal as the ranging information.

30. An apparatus comprising:
means for receiving at a ranging terminal a request for assistance in determining a position estimate for a target terminal;
means for obtaining ranging information suitable for determining the position estimate for the target terminal; and
means for sending a response with the ranging information.

31. The apparatus of claim 30, wherein the means for obtaining the ranging information comprises
means for obtaining a ranging measurement for the request received from the target terminal, and
means for providing the ranging measurement and a position of the ranging terminal as the ranging information.

32. An apparatus comprising:
at least one processor configured to receive at least one response from at least one ranging terminal for a request sent by a target terminal for assistance in determining a position estimate for the target terminal, and to determine the position estimate for the target terminal based on the at least one response from the at least one ranging terminal, wherein each response includes ranging information suitable for determining the position estimate for the target terminal; and
a memory coupled to the at least one processor.

33. The apparatus of claim 32, wherein the at least one processor is configured to send the position estimate to the target terminal.

34. The apparatus of claim 32, wherein the ranging information from each ranging terminal comprises a ranging measurement made by the ranging terminal for the request sent by the target terminal and a position of the ranging terminal.

35. The apparatus of claim 34, wherein the at least one processor is configured to estimate a distance between the target terminal and each ranging terminal based on the ranging measurement made by the ranging terminal, and to determine the position estimate for the target terminal based on the estimated distance and the position for each of the at least one ranging terminal.

36. The apparatus of claim 34, wherein the at least one processor is configured to remove a timing offset of each ranging terminal from the ranging measurement made by the ranging terminal.

37. The apparatus of claim 34, wherein the at least one processor is configured to remove a timing offset of the target terminal from the ranging measurement made by each ranging terminal.

38. The apparatus of claim 32, wherein the at least one processor is configured to obtain at least one ranging measurement for at least one transmitter received by the target terminal, and to determine the position estimate for the target terminal further based on the at least one ranging measurement for the at least one transmitter.

39. An apparatus comprising:
means for receiving at least one response from at least one ranging terminal for a request sent by a target terminal for assistance in determining a position estimate for the target terminal, wherein each response includes ranging information suitable for determining the position estimate for the target terminal; and
means for determining the position estimate for the target terminal based on the at least one response from the at least one ranging terminal.

40. The apparatus of claim 39, wherein the means for determining the position estimate for the target terminal comprises
means for estimating a distance between the target terminal and each ranging terminal based on a ranging measurement made by the ranging terminal, and
means for determining the position estimate for the target terminal based on the estimated distance and a position for each of the at least one ranging terminal.
